(19) United States
(12) Patent Application Publication
(10) Pub. No.: US 2015/0379652 A1
(43) Pub. Date: Dec. 31, 2015

(54) USER ENFORCEABLE CONTRACT JURISDICTION SELECTION

(71) Applicant: ADOBE SYSTEMS INCORPORATED, San Jose, CA (US)

(72) Inventor: BENJAMIN DAVID FOLLIS, Redwood City, CA (US)

(21) Appl. No.: 14/316,317

(22) Filed: Jun. 26, 2014

(51) Int. Cl. G06Q 50/18; G06Q 10/10

(52) U.S. Cl. CPC G06Q 50/18; G06Q 10/10

(57) ABSTRACT

Mappings are received that associate one or more contract classes to one or more jurisdictions. Contract classes are determined for contracts being sent by senders or signed by signers. The contract classes may be determined by content analysis performed on the contracts. Content of the contracts may be altered with clauses specifying jurisdictions in accordance with the mappings. The contracts are enabled to be sent by senders or signed by signers.

### BACKGROUND

Parties to contracts often spend a significant amount of time selecting and negotiating particular clauses within the contracts. The sender or signer of a contract being sent for electronic signature may not always be aware of clauses or details within the clauses that are acceptable to their organization. Some of these clauses or details may be dependent upon the type of contract or a party to the contract. For example, legal experts for an organization may have spent many hours determining the appropriate forum or choice or law should a particular type of contract or a contract with a particular party be disputed. The sender or signer may be unaware of this determination, unwilling to send the contract for review prior to sending or signing the contract, or unable to send the contract for review because of time constraints. Each of these scenarios may result in drastic consequences for the sender's or signer's organization.

### SUMMARY

This summary is provided to introduce a selection of concepts in a simplified form that are further described below in the Detailed Description. This summary is not intended to identify key features or essential features of the claimed subject matter, nor should it be used as an aid in determining the scope of the claimed subject matter.

Embodiments of the present invention generally relate to altering the content of a contract with a clause specifying a jurisdiction in accordance with a mapping received from a sender or a signer. Utilizing a jurisdiction service, a mapping associating one or more contract classes to one or more jurisdictions is received from a sender or signer. A contract class for a contract being sent by a sender or signed by a signer is determined. Content of the contract is altered with a clause specifying a jurisdiction in accordance with the mapping. The contract is enabled to be sent by the sender or signed by the signer. Accordingly, an acceptable jurisdiction is included in the contract.

### BRIEF DESCRIPTION OF THE DRAWINGS

The present invention is described in detail below with reference to the attached drawing figures, wherein:

FIG. 1 is a block diagram of an exemplary system architecture in which embodiments of the invention may be employed;

FIG. 2 is a flow diagram showing a method for altering content of a contract with a clause specifying a jurisdiction, in accordance with an embodiment of the present invention;

FIG. 3 is a flow diagram showing a method for altering the content of a contract in accordance with a sender mapping, in accordance with an embodiment of the present invention;

FIG. 4 is a flow diagram showing a method for determining if the jurisdiction specified in a contract matches one or more signer jurisdictions, in accordance with an embodiment of the present invention;

FIG. 5 is a flow diagram showing a method for amending the content of a contract with a new clause specifying a new jurisdiction based on a comparison of the acceptable jurisdictions received from the sender and the signer, in accordance with an embodiment of the present invention; and

FIG. 6 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. Definitions of some terms are included below to provide a clearer understanding of the ideas disclosed herein:

A “sender” refers to a person or entity utilizing a signature service to request that one or more persons electronically sign a document.

A “signer” refers to the one or more persons being requested by the sender via the signature service to electronically sign the document. A “signer” may additionally refer to one or more persons present during the signing of the document (i.e., witnesses).

A “jurisdiction service” refers to an on-line service that is accessed via a network by senders and/or signers to provide the benefits described herein. The jurisdiction service associates one or more contract classes to one or more jurisdictions. As can be appreciated, any type of contract class may be associated with one or more jurisdictions by the jurisdiction service. The jurisdiction service may further associate one or more organizations to one or more jurisdictions, allowing the jurisdiction server to associate one or more contract classes to one or more jurisdictions based on a party or parties to the contract. A jurisdiction service may include or be associated with a signature service.

A “jurisdiction” refers to a particular forum, a particular choice of law, and/or a particular type of dispute resolution (e.g., mediation, arbitration, etc.). The jurisdiction may be associated with a particular contract class (e.g., intellectual property, real estate, purchase orders, leases, nondisclosure, consulting, and the like) or a particular clause within a contract.

A “signature service” refers to an on-line service that is accessed via a network by senders and/or signers and maintains information about senders, signers, and contracts, sufficient to legally enforce the contracts. A signature service may then record the identification and the electronic signature of the signer to the contract. Adobe® Echosign® is an example of such signature service. A signature service may include or be associated with a jurisdiction service.

A “contract” refers to any document that is being sent by a sender to a signer for signature. The contract may be stored in a database and accessed by the jurisdiction service to determine a contract class and/or jurisdiction acceptable to the sender and/or signer of the contract. The database may further store changes to the jurisdiction made by the sender or signer for tracking or reporting purposes.

A “contract class” refers to types of contracts, such as intellectual property, real estate, purchase orders, leases, nondisclosure, consulting, and the like.

As discussed previously, a significant amount of time may be spent by parties to a contract selecting and negotiating particular clauses within the contract. In many instances, a person associated with one of the organizations that is a party to the contract may not be aware of acceptable clauses, may be unwilling to send the contract for review prior to sending or signing the contract, or may be unable to send the contract for review because of time constraints. This may result in undesirable consequences for the person's organization.

Embodiments of the present invention provide, among things, altering the content of a contract with a clause specifying a jurisdiction. As will be discussed in further detail below, a jurisdiction service may receive a mapping that associates one or more contract classes to one or more jurisdictions. Generally, an identification of a contract classes is determined. Content of the contract is altered with a clause specifying a jurisdiction in accordance with the mapping. After the contract has been altered, the contract is enabled to be sent by the sender or signed by the signer. In some embodiments, the jurisdiction service may compare mappings between parties to the contract to determine a jurisdiction acceptable to all parties. In some embodiments, the jurisdiction prevents the sender from sending a contract to a signer that includes or excludes content that is not in accordance with the sender mapping. Similarly, in some embodiments the jurisdiction service prevents the signer from signing a contract or provides a warning to the signer if a contract includes or excludes content that is not in accordance with the signer mapping. In some embodiments, changes associated with the jurisdiction are tracked and recorded for audit purposes or to notify the parties to the contract. In some embodiments, the jurisdiction services makes automated decisions based on real-time changes made to the contract.

Accordingly, in one aspect, an embodiment of the present invention is directed to a non-transitory computer storage medium storing computer-useable instructions that, when used by one or more computing devices, cause the one or more computing devices to perform operations. The operations include receiving a sender mapping that associates one or more contract classes to one or more sender jurisdictions. The operations also include receiving an identification of a contract class for a contract being sent by a sender to a signer. The operations further include altering the content of the contract with a clause specifying a jurisdiction in accordance with the sender mapping. The operations also include sending the contract to the signer.

In another embodiment of the invention, an aspect is directed to a computer-implemented method. The method includes receiving a mapping that associates one or more contract class to one or more jurisdictions. The method also includes determining a contract class for a contract being sent by a sender or signed by a signer. The method further includes altering the content of the contract with a clause specifying a jurisdiction in accordance with the mapping. The method also includes enabling the contract to be sent by the sender or signed by the signer.

A further embodiment is directed to a system that includes one or more processors; and a non-transitory computer storage medium storing computer-useable instructions that, when used by the one or more processors, cause the one or more processors to: receive a mapping that associates one or more contract classes to one or more jurisdictions; determine a contract class for a contract being sent by a sender or signed by a signer; specify a jurisdiction in accordance with the mapping in the content of the contract; enable the contract to be sent by the sender or signed by the signer based on a determination that the jurisdiction is acceptable to the sender and the signer; and notify the sender or the signer if any changes are made to the jurisdiction.

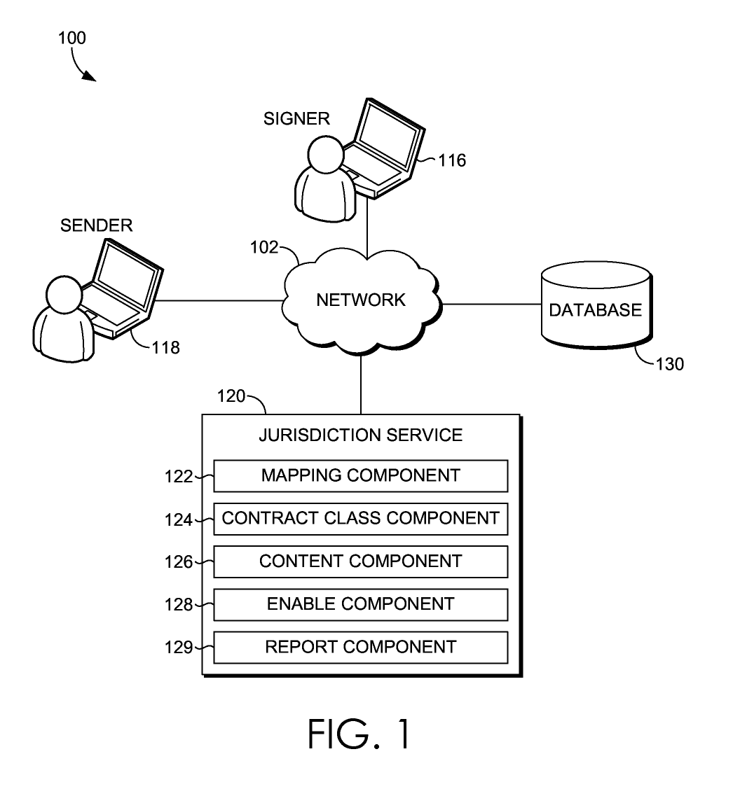

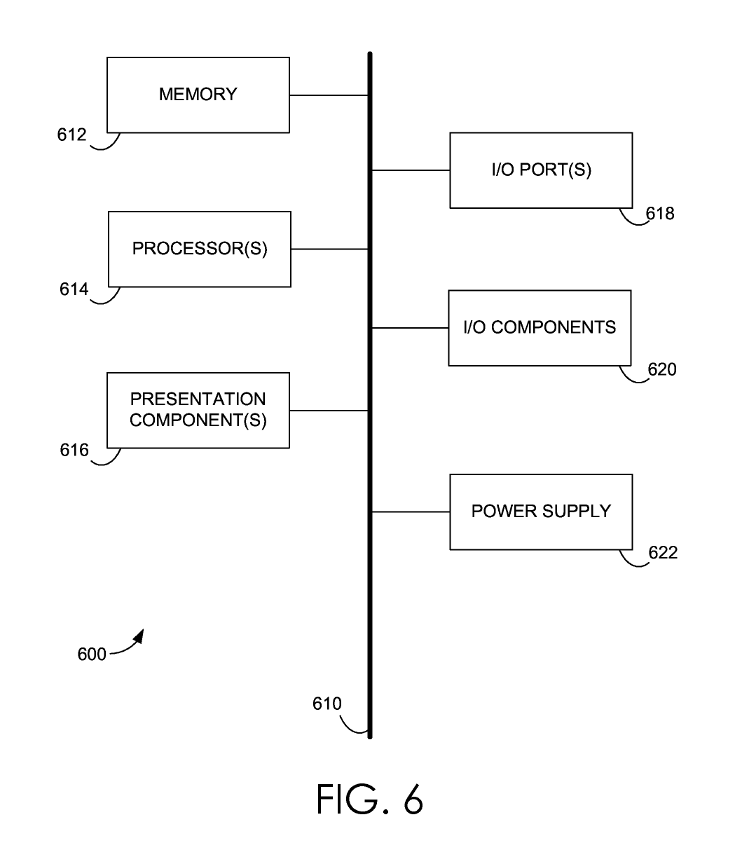

Referring now to FIG. 1, a block diagram is provided illustrating an exemplary system 100 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The jurisdiction system 100 may be implemented via any type of computing device, such as computing device 600 described below with reference to FIG. 6, for example. In various embodiments, the jurisdiction system 100 may be implemented via a single device or multiple devices cooperating in a distributed environment.

The system generally operates to alter the content of a contract with a clause specifying a jurisdiction in accordance with a mapping associating one or more contract classes to one or more jurisdictions. Among other components not shown, the system 100 may include a signer device 116, a sender device 118, a jurisdiction service 120, and a database 130. It should be understood that the system 100 shown in FIG. 1 is an example of one suitable computing system architecture. Each of the components shown in FIG. 1 may be implemented via any type of computing device, such as computing device 600 described with reference to FIG. 6, for example. The components may communicate with each other via a network 102, which may include, without limitation, one or more local area networks (LANs) and/or wide area networks (WANs). Such networking environments are commonplace in offices, enterprise-wide computer networks, intranets, and the Internet. It should be understood that any number of sender devices, signer devices, jurisdiction services, and databases may be employed within the system 100 within the scope of the present invention. Each may comprise a single device or multiple devices cooperating in a distributed environment. For instance, the jurisdiction service 120 may be provided via multiple devices arranged in a distributed environment that collectively provide the functionality described herein. In another instance, the jurisdiction service 120 and one or more of the other components that comprise the system 100 may be provided by a single device. Additionally, other components not shown may also be included within the network environment.

The jurisdiction service 120 may be employed by a sender or signer of a contract to assist in determining the appropriate jurisdiction for a contract, allowing the contract to be sent or signed, and maintaining an audit trail of changes to the jurisdiction. The sender may communicate a contract to the jurisdiction service 120 that requires an electronic signature from the signer. As shown in FIG. 1, the jurisdiction service 120 includes, among other things not shown, a mapping component 122, a contract class component 124, a content component 126, an enable component 128, and a report component 129.

Mapping component 122 receives a mapping that associates one or more contract classes to one or more jurisdictions. The mapping may be provided by a sender and/or a signer. The mapping may further associate one or more parties to one or more jurisdictions. In other words, the mapping may indicate that if a particular party is involved in the contract, then one or more jurisdictions are acceptable. The mapping may be stored in database 130 and subsequently retrieved from storage by the jurisdiction service 220. The mapping may be requested by the jurisdiction service 120, a signature service, the signer, or the sender of the contract. In various embodiments, the mapping component 122 may receive the mapping before the contract is enabled to be communicated by the sender device 118 or before the contract is enabled to be signed by the signer device 116.

Upon the mapping being received by mapping component 122, contract class component 124 determines a contract class for a contract being sent by a sender or signed by a signer. The contract class may be manually selected by the sender or the signer. The contract class may be automatically determined by the jurisdiction service. For example, the contract class component 124 may perform content analysis to automatically determine the contract class. Certain keywords, parties to the contract, or clauses within the contract may indicate that the contract should be associated with a particular contract class. Similarly, the contract class component 124 may perform content analysis to determine possible jurisdictions specified within the terms of the contract. This analysis may be utilized to determine whether the possible jurisdictions identified by the content analysis match the one or more jurisdictions associated with the contract class in accordance with the mapping received by the mapping component 122. If the possible jurisdictions do not match the one or more jurisdictions associated with the contract class in accordance with the mapping received by the mapping component 122, a warning may be provided to the sender or signer or the sender or signer may be prevented from sending or signing the contract.

Content component 126 specifies a jurisdiction in accordance with the mapping in the content of the contract. If a jurisdiction has already been specified within the content of the contract, but do not match the one or more jurisdictions associated with the contract class in accordance with the mapping received by the mapping component 122, the content component 126 alters the jurisdiction in accordance with the mapping. If the jurisdiction has already been specified within the content of the contract and matches the one or more jurisdictions associated with the contract class in accordance with the mapping received by the mapping component 122, the content component 126 determines the jurisdiction is acceptable to the sender and/or the signer.

Enable component 128 enables the contract to be sent by the sender or signed by the signer based on the determination made by the content component 126. Enable component 128 may further facilitate an automated negotiation to determine an acceptable jurisdiction for each party to a contract where one or more jurisdictions are included in the mapping received by mapping component 122 for both the sender and the signer. In other words, if the mapping component 122 has received a mapping from the sender and the signer, enable component 128 may reconcile the mappings to determine acceptable jurisdictions associated with the contract class that are common to both the sender and the signer.

Once the enable component 128 has determined one or more common jurisdictions, content component 126 specifies one of the one or more common jurisdictions and the enable component 128 enables the contract to be sent and/or signed. Enable component 128 may additionally make automated decisions or include notes within the contract based on real-time occurrences, such as the selection of a party to the contract, the inclusion of a particular clause or term within the contract, the identification of a particular person within the contract, and the like. The decisions may include altering the contract as described herein, notifying a party to the contract, providing an alert or warning to the sender or signer, or including notes within the contract.

Report component 129 notifies the sender or the signer if any changes are made to the jurisdiction by either party. For example, content component may alter the jurisdiction when the jurisdiction does not match the one or more jurisdictions associated with the contract class in accordance with the mapping received by the mapping component 122. Similarly, after the jurisdiction service 120 enables the sender to send the contract to the signer, a mapping associated with the signer may cause the jurisdiction to be altered. In this instance, report component 129 records the changes and notifies the parties. When the automated negotiation is performed by the enable component 128, there may be multiple acceptable jurisdictions. However, one party may designate one jurisdiction as preferred over another. Upon altering the contract with the preferred jurisdiction, report component 129 may record this preference and notify the parties accordingly.

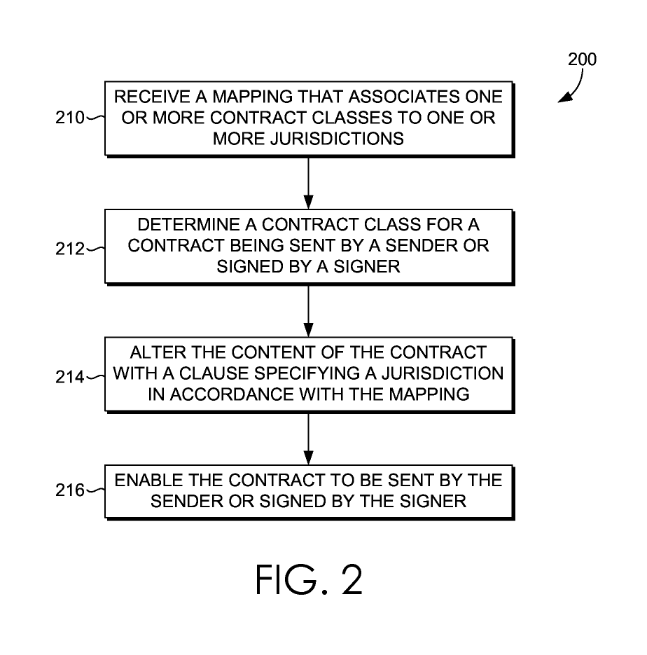

Referring to FIG. 2, a flow diagram is provided that illustrates a method 200 for altering content of a contract with a clause specifying a jurisdiction, in accordance with an embodiment of the present invention. Initially, at step 210, a mapping is received that associates one or more contract classes to one or more jurisdictions. The mapping may be received from a sender and/or a signer. A contract class is determined, at step 212, for a contract being sent by a sender or signed by a signer. The content of the contract may be analyzed to automatically determine the contract class. Alternatively, the contract class may be manually selected by the sender or the signer.

At step 214, the content of the contract are altered with a clause specifying a jurisdiction in accordance with the mapping. At step 216, the contract is enabled to be sent by the sender or signed by the signer. In one embodiment, changes to the clause made by the sender or signer are tracked. In one embodiment, parties to the contract are alerted of the changes.

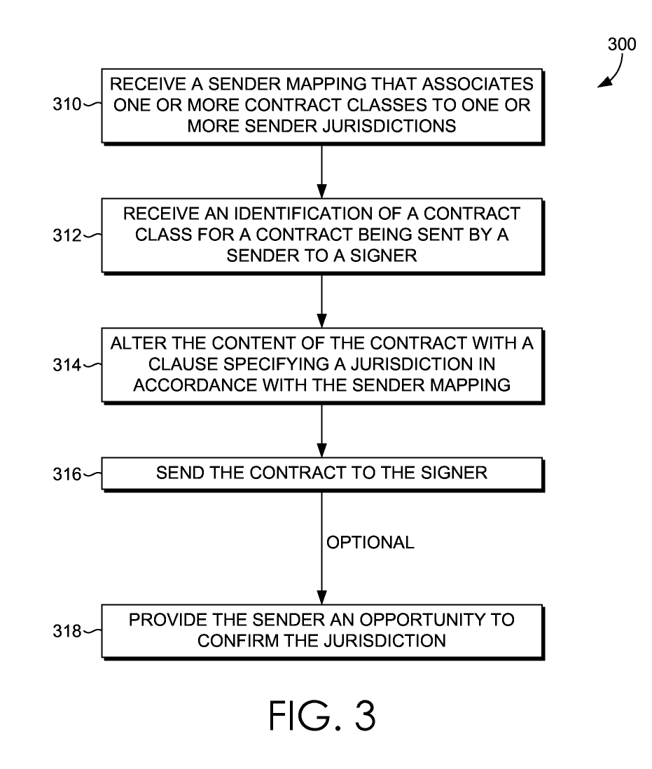

Turning now to FIG. 3, a flow diagram is provided that illustrates a method 300 for altering the content of a contract in accordance with a sender mapping, in accordance with embodiments of the present invention. Initially, at step 310, a sender mapping is received that associates one or more contract classes to one or more sender jurisdictions. The sender mapping may further associate one or more parties to the contract to one or more sender jurisdictions.

At step 312, an identification of a contract class is received for a contract being sent by a sender to a signer. The content of the contract may be analyzed by performing content analysis on the contract to automatically determine the contract class. Content of the contract are altered, at step 314, with a clause specifying a jurisdiction in accordance with the sender mapping. The contract is sent to the signer at step 316.

The jurisdiction may be automatically selected in accordance with the sender mapping. The sender may be provided with an opportunity to confirm the jurisdiction, at step 318, prior to altering the contract or prior to sending the contract. Additionally or alternatively, the sender may be provided with an opportunity to select an alternate jurisdiction in accordance with the sender mapping prior to sending the contract. The service may enable the sender to authorize sending the contract without providing the sender with an opportunity to confirm the jurisdiction prior to sending the contract.

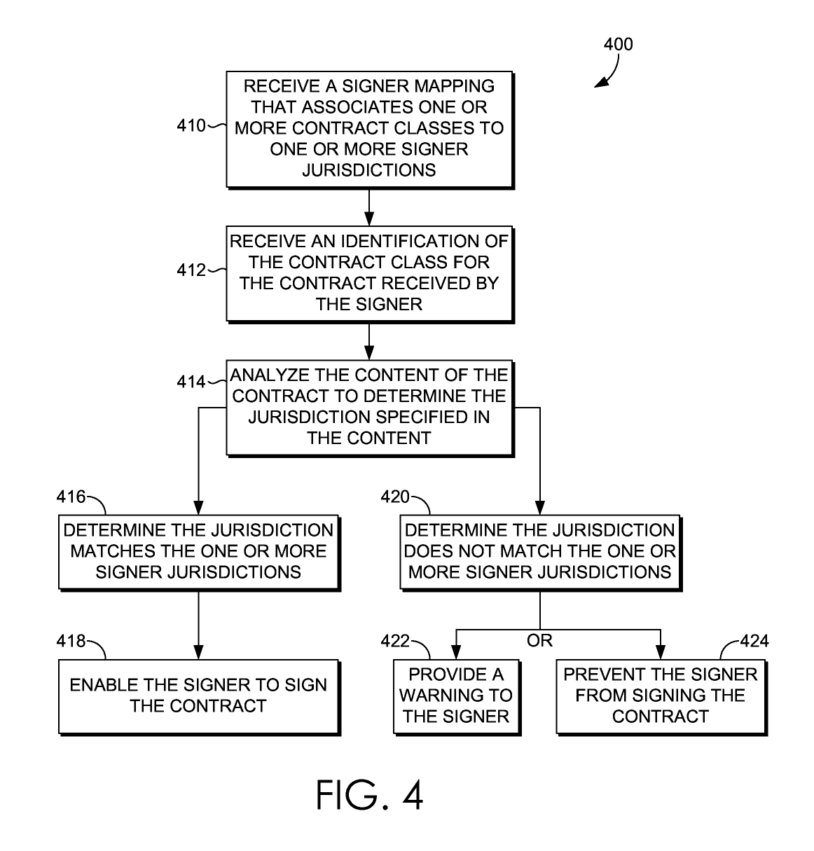

With reference now to FIG. 4, a flow diagram is provided that illustrates a method 400 for determining if the jurisdiction specified in a contract matches one or more signer jurisdictions, in accordance with embodiments of the present invention. As shown at step 410, a signer mapping may be received that associates one or more contract classes to one or more signer jurisdictions. An identification of the contract class for the contract received by the signer may be received at step 412. The identification may be based on information received from the sender, the sender, the jurisdiction service, and/or the signature service, and/or content analysis. The signer may be provided an opportunity to confirm the contract class and/or jurisdiction. The content of the contract may be analyzed, at step 414, to determine the jurisdiction specified in the content. The signer may be provided an opportunity to confirm the contract class and/or jurisdiction. If no jurisdiction has been specified, the content of the contract may be analyzed to automatically determine the jurisdiction for the contract received by the signer in accordance with the signer mapping.

At step 416, if it is determined the jurisdiction matches the one or more signer jurisdictions, the contract is enabled to be signed by the signer at step 418. If, however, it is determined the jurisdiction does not match the one or more signer jurisdictions at step 420, a warning may be provided, at step 422, to the signer, or the signer may be prevented, at step 424, from signing the contract.

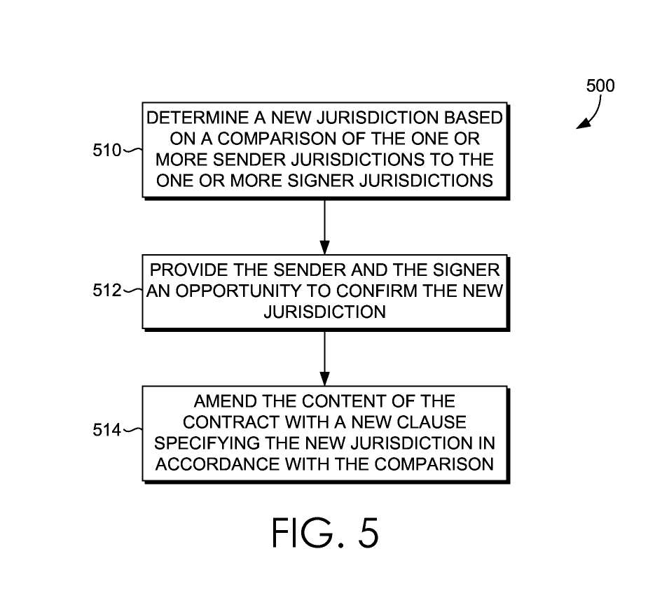

With reference now to FIG. 5, a flow diagram is provided that illustrates a method 500 for amending the content of a contract with a new clause specifying a new jurisdiction based on a comparison of the acceptable jurisdictions received from the sender and the signer, in accordance with embodiments of the present invention. As shown at step 510, a new jurisdiction may be determined based on a comparison of the one or more sender jurisdictions to the one or more signer jurisdictions. The sender and the signer may be provided an opportunity to confirm the new jurisdiction at step 512. The content of the contract may be amended, at step 514, with a new clause specifying the new jurisdiction in accordance with the comparison.

Having described embodiments of the present invention, an exemplary operating environment in which embodiments of the present invention may be implemented is described below in order to provide a general context for various aspects of the present invention. Referring to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output (I/O) ports 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer-storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as, stereoscopic camera systems, infrared camera systems, RGB camera systems, and combinations of these for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

As can be understood, embodiments of the present invention provide for, among other things, altering content of a contract with clauses specifying a jurisdiction in accordance with a mapping received from a sender or signer of the contract. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A non-transitory computer storage medium storing computer-useable instructions that, when used by one or more computing devices, cause the one or more computing devices to perform operations comprising:
receiving, at a jurisdiction service, a sender mapping that associates one or more contract classes to one or more sender jurisdictions;
receiving, at the jurisdiction service, an identification of a contract class for a contract being sent by a sender to a signer;
altering, by the jurisdiction service, the content of the contract with a clause specifying a jurisdiction in accordance with the sender mapping; and
sending, by the jurisdiction service, the contract to the signer.

2. The non-transitory computer storage medium of claim 1, further comprising analyzing, by the jurisdiction service, the content of the contract to automatically determine the contract class.

3. The non-transitory computer storage medium of claim 2, further comprising automatically selecting, by the jurisdiction service, the jurisdiction in accordance with the sender mapping.

4. The non-transitory computer storage medium of claim 3, further comprising providing, by the jurisdiction service, the sender with an opportunity to confirm the jurisdiction prior to sending the contract.

5. The non-transitory computer storage medium of claim 3, further comprising providing, by the jurisdiction service, the sender with an opportunity to select an alternate jurisdiction in accordance with the sender mapping prior to sending the contract.

6. The non-transitory computer storage medium of claim 3, further comprising enabling, by the jurisdiction service, the sender to authorize sending the contract without providing the sender with an opportunity to confirm the jurisdiction prior to sending the contract.

7. The non-transitory computer storage medium of claim 1, further comprising receiving, at the jurisdiction service, a signer mapping that associates one or more contract classes to one or more signer jurisdictions.

8. The non-transitory computer storage medium of claim 7, further comprising receiving, at the jurisdiction service, the identification of the contract class for the contract received by the signer.

9. The non-transitory computer storage medium of claim 8, further comprising analyzing, by the jurisdiction service, the content of the contract to determine the jurisdiction specified in the content.

10. The non-transitory computer storage medium of claim 9, further comprising determining, by the jurisdiction service, the jurisdiction does not match the one or more signer jurisdictions.

11. The non-transitory computer storage medium of claim 10, further comprising providing, by the jurisdiction service, a warning to the signer.

12. The non-transitory computer storage medium of claim 10, further comprising preventing, by the jurisdiction service, the signer from signing the contract.

13. The non-transitory computer storage medium of claim 7, further comprising analyzing, by the jurisdiction service, the content of the contract to the automatically determine the contract class and the jurisdiction for the contract received by the signer.

14. The non-transitory computer storage medium of claim 13, further comprising providing, by the jurisdiction service, the signer an opportunity to confirm the contract class and the jurisdiction.

15. The non-transitory computer storage medium of claim 7, further comprising determining, by the jurisdiction service, a new jurisdiction based on a comparison of the one or more sender jurisdictions to the one or more signer jurisdictions.

16. The non-transitory computer storage medium of claim 15, providing, by the jurisdiction service, the sender and the signer an opportunity to confirm the new jurisdiction.

17. The non-transitory computer storage medium of claim 16, further comprising amending, by the jurisdiction service, the content of the contract with a new clause specifying the new jurisdiction in accordance with the comparison.

18. A computer-implemented method comprising:
receiving, at a jurisdiction service, a mapping that associates one or more contract class to one or more jurisdictions;
determining a contract class for a contract being sent by a sender or signed by a signer;
altering, by the jurisdiction service, the content of the contract with a clause specifying a jurisdiction in accordance with the mapping; and
enabling, by the jurisdiction service, the contract to be sent by the sender or signed by the signer.

19. The computer-implemented method of claim 18, further comprising tracking, by the jurisdiction service, changes to the clause made by the sender or signer and alerting parties to the contract of the changes.

20. A system comprising:
one or more processors; and
a non-transitory computer storage medium storing computer-useable instructions that, when used by the one or more processors, cause the one or more processors to:
receive, at a jurisdiction service, a mapping that associates one or more contract classes to one or more jurisdictions;
determine a contract class for a contract being sent by a sender or signed by a signer;
specify, by the jurisdiction service, a jurisdiction in accordance with the mapping in the content of the contract;
enable, by the jurisdiction service, the contract to be sent by the sender or signed by the signer based on a determination that the jurisdiction is acceptable to the sender and the signer; and
notify, by the jurisdiction service, the sender or the signer if any changes are made to the jurisdiction.
